(19) United States
(12) Patent Application Publication
(10) Pub. No.: US 2012/0187038 A1
(43) Pub. Date: Jul. 26, 2012

(54) PRESSURE FILTER DEVICE

(76) Inventor: Albert Schick, Brackenheim (DE)

(21) Appl. No.: 13/498,845

(22) PCT Filed: Aug. 31, 2010
(86) PCT No.: PCT/EP2010/062688

§ 371 Date: Mar. 28, 2012

(30) Foreign Application Priority Data
Sep. 29, 2009 (DE) 102009043638.3

(51) Int. Cl. B01D 35/01

(52) U.S. Cl. 210/436

(57) ABSTRACT

A pressure filter device may include a filter housing having a filter housing pot and a filter housing cover connected to the filter housing pot in a pressure-tight manner. At least one filter element may be arranged in the filter housing. A vent line may be secured on the filter housing pot and connected to a crude-side gas collection region located directly beneath the filter housing cover to a tank.

### CROSS-REFERENCE TO RELATED APPLICATIONS

This application claims priority to German Patent Application 10 2009 043 638.3 filed on Sep. 29, 2009 and PCT/EP2010/062688 filed on Aug. 31, 2010, which are hereby incorporated by reference in their entireties.

### TECHNICAL FIELD

The present invention relates to a pressure filter device, in particular a hydraulic filter device, according to the preamble of the claim 1.

### BACKGROUND

In known pressure filter devices it is often the case that also air is separated in a filter housing of said pressure filter device and accumulates directly beneath a filter housing cover. If this air is not discharged, its volume increases constantly and thereby reduces the filter area available for the liquid to be filtered. Thus, if the accumulating air is not discharged, for example, in a vertically arranged filter element, no flow can pass through a region that constantly expands beginning from the top and therefore is not utilized. In addition, in the case of a bypass, an air stream can occur which, especially in the case of a bypass, supplies a system with an insufficient amount of oil and therefore can cause damage to the bearings. In particular in open systems, a large amount of air is introduced and separated, for example, at the filter element, wherein vent lines which are provided on the filter housing cover and through which such filter devices are vented are already known. However, a disadvantage of the known vent lines is that when changing the filter element, due to their arrangement on the filter housing cover, said vent lines have first to be time-consumingly disassembled and subsequently assembled again.

### SUMMARY

The present invention is based on the general idea, in the case of a pressure filter device, for example a hydraulic filter device, to attach a vent line to a filter housing pot, wherein the vent line arranged according to the invention connects a crude-side gas collection region located directly beneath the filter housing cover to a (hydraulic liquid) tank. Moreover, within the filter housing, which preferably consists of a filter housing pot and a filter housing cover that can be connected in a pressure-tight manner to said pot, a filter element is arranged which effects the actual filter function. When changing the filter element, the inventive arrangement of the vent line on the filter housing pot allows to first unscrew the filter housing cover in a simple manner and to subsequently remove the filter element without the need of a complicated disassembly of the vent line. Assembling a new filter element takes place in the same simple manner, wherein here too, a complicated assembly of the vent line is eliminated. As an alternative to this, it can be provided that the vent line is fixed to the filter element itself and is fed through an upper end disk of the same, wherein in this case, the vent line connects, via a pure side, the crude-side gas collection region located directly beneath the filter housing cover to the tank, in particular to the hydraulic liquid tank. In this case, the vent line is integral part of the filter element and can easily be changed together with the latter. Connecting the vent line to the tank can be carried out, for example, in that on a lower end disk of the filter element, a hollow pin is arranged which engages in a return line running to the tank, wherein the vent line is connected via the hollow pin in a communicating manner to the return line. Both solutions have the great advantage that a complicated assembly or disassembly of the respective vent line during a change of the filter element is no longer required, whereby the handling of the pressure filter device according to the invention is significantly simplified.

In an advantageous refinement of the solution according to the invention, the vent line, at least in the gas collection region, is configured as a flexible hose element which is capable of adapting to an inner contour of the filter housing cover. Due to its elasticity, such a flexible hose element can additionally act as a throttle thereby preventing an undesirable bypass flow during the operation of the pressure filter device. In general, such a flexible hose element can be produced in an extremely cost-effective manner and, moreover, it does not interfere in any way with the assembly or disassembly of the filter element.

In a further advantageous embodiment of the solution according to the invention, the vent line, at least in the gas collection region, is configured as a rigid pipe element which, with regard to its shape, is adapted to an inner contour of the filter housing cover. This has the great advantage that the vent line in the gas collection region, which is important for venting, is always arranged in a defined manner, wherein a position change, as it can occur, for example, in the case of a vent line that is configured as a flexible hose element, can be avoided. Likewise, such a rigid pipe element does not interfere with assembly and disassembly of the filter element if, for example, in addition, an articulated joint is provided in a transition region between the filter housing cover and the filter housing pot, which articulated joint enables pivoting of that section of the vent line which extends into the gas collection region.

Further important features and advantages of the invention arise from the sub-claims, from the drawings, and from the associated description of the figures based on the drawings.

It is to be understood that the above mentioned features and the features still to be explained hereinafter are not only usable in the respective mentioned combination but also in other combinations or alone without departing from the context of the present invention.

Preferred exemplary embodiments of the invention are illustrated in the drawings and are explained in the following description in more detail, wherein identical reference numbers refer to identical, or similar, or functionally identical components.

### BRIEF DESCRIPTION OF THE DRAWINGS

In the figures, schematically

FIG. 1 shows a sectional view through a pressure filter device according to the invention,

FIG. 2 shows an illustration as in FIG. 1, but with a filter device of another embodiment,

FIG. 3 shows a further embodiment of the pressure filter device according to the invention.

### DETAILED DESCRIPTION

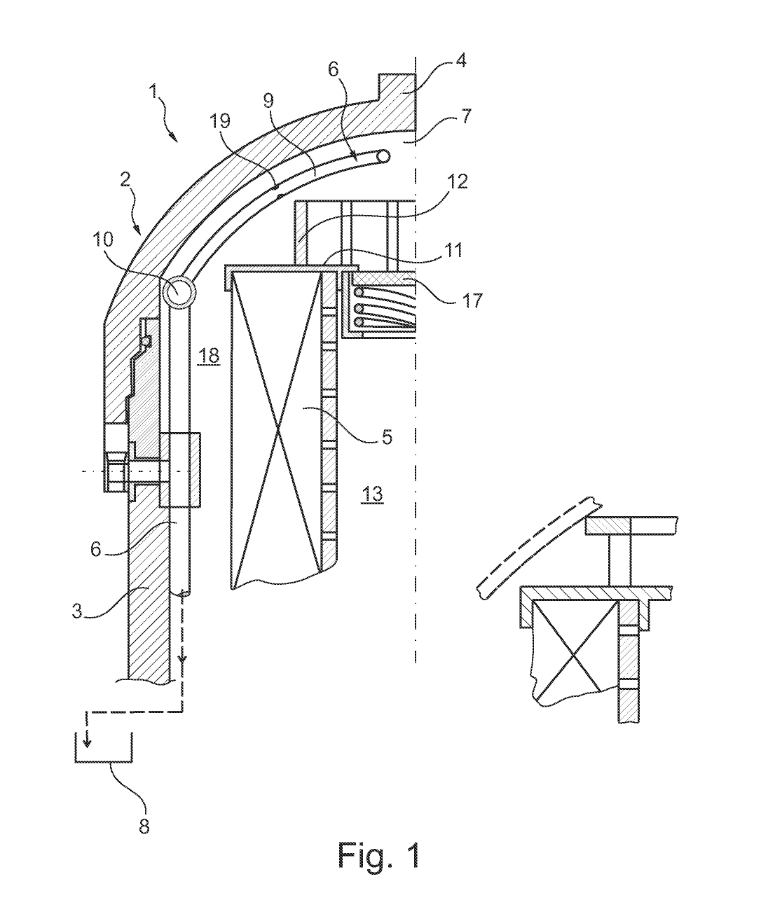

According to FIG. 1, a pressure filter device 1 according to the invention which can in particular be configured as a hydraulic filter device and, for example, operates in a pressure range of ca. 16 to 20 bar, comprises a filter housing 2 which substantially consists of a filter housing pot 3 and, in particular, a screwable filter housing cover 4 which can be connected in a pressure-tight manner to said filter housing pot. Within the filter housing 2, of which according to the FIGS. 1 to 3 in each case only a left half is illustrated, a filter element 5, in particular of the type of a ring filter element, is arranged. On the filter housing pot 3 of a pressure filter device 1 according to the FIGS. 1 and 3, according to the invention, a vent line 6 is attached which connects a crude-side gas collection region 7 located directly beneath the filter housing cover 4 to a (hydraulic liquid) tank 8. In general, the tank 8 can be configured as a lubricating oil tank if the pressure filter device 1 involves a lubricating oil device. The vent line 6 provides for a permanent venting of the pressure filter device 1, whereby it can be reliably ensured that a filter area of the filter element 5 can be completely exposed to liquid to be filtered and thereby, a filter effect over the entire filter area is generated. Permanent venting of the pressure filter device 1 therefore ensures a constant high filtration performance of the same.

According to the pressure device 1 shown according to FIG. 1, the vent line 6 of the latter is configured, at least in the gas collection region 7, as a rigid pipe element which, with regard to its shape, is adapted to an inner contour of the filter housing cover 4. After unscrewing the filter housing cover 4, the vent line 6 with its section 9 protruding into the gas collection region 7 can be tilted about an articulated joint 10 and in this way, the filter element 5 can be easily removed from the filter housing pot 3. Here, the vent line 6 can penetrate the filter housing pot 3 in a lateral surface (as illustrated according to FIG. 1) or in a non-illustrated bottom region, wherein the vent line 6 is connected in both cases to the tank 8.

In contrast, in the pressure filter device 1 according to FIG. 3, the vent line 6 is configured, at least in the gas collection region 7, as a flexible hose element which is capable of adapting to an inner contour of the filter housing cover 4. The section 9 of the vent line 6 according to FIG. 3 is therefore configured as a flexible hose element and, for example by means of a support geometry 12 attached to the filter element 5 or to an upper end disk 11 of the filter element 5, is positioned with its inlet just beneath the highest point of the filter housing cover 4. At the support geometry 12 formed on the upper end disk 11 of the filter element 5, passages 20 can be provided which allow for a bypass flow if the filter element 5 is clogged. Also in this case, the vent line 6 can be fed, for example, through a lateral surface of the filter housing pot 3 or through a bottom of the latter and can be connected in a communicating manner to the tank 8. The vent line 6 fed through the bottom of the filter housing pot 3 is only drawn with a broken line, thus is optional. In general, the geometry of the upper end disk 11 can be configured such that the vent line 6, thus, for example the hose or the pipe, is placed such that it is always at the highest point beneath the filter housing cover 4. In addition, the end disk geometry allows for a flow in the case of a bypass. It is also conceivable that the vent line 6, after the filter element 5 has been installed, is latched, in particular clipped, in the correct position to the upper end disk 11.

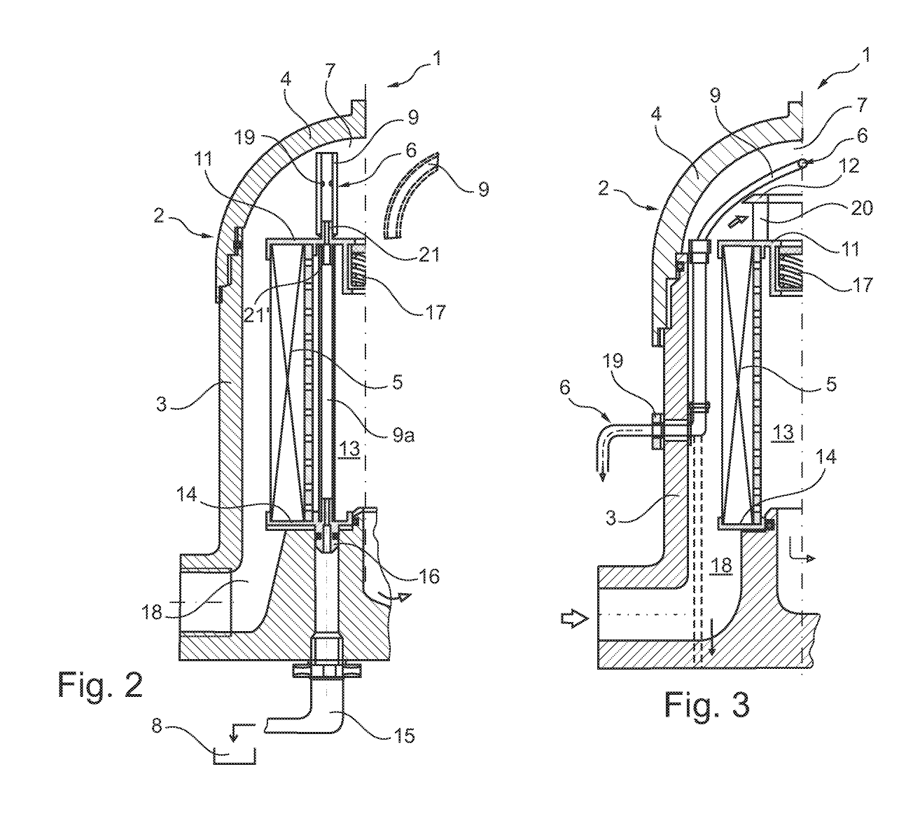

Alternatively, in the pressure filter device 1 drawn according to FIG. 2, the vent line 6 is arranged or secured on the filter element 5 and is fed through the upper end disk 11 of the same. The vent line's 6 section 9 protruding into the gas collection region 7 can be rigid or can be configured as a flexible hose element. As is apparent from FIG. 2, the vent line 6 runs from the gas collection region 7 through the upper end disk 11 of the filter element 5 for a pure side 13 of the latter and through a lower end disk 14 and a subsequent drain channel 15 to the tank 8. At its lower end disk 14, the filter element 5 has a hollow pin 16 which engages in the drain channel 15 on the filter housing pot side and forms at the same time a segment of the vent line 6. The vent line's 6 section 9a located between the upper end disk 11 and the lower end disk 14 can optionally be configured as rigid pipe element or as a flexible hose element. In the embodiment according to FIG. 2, inwardly and outwardly protruding nozzles 21, 21′ are formed on the upper end disk 11 of the filter element 5, wherein the vent line 6 is connected with its respective sections 9 and 9a to said nozzles.

In general, a bypass valve 17 can additionally be arranged on the filter element 5, wherein in the case of a clogged filter element 5, said bypass valve connects a crude side 18 to a pure side 13 of the filter element. In general, the pressure filter device 1 according to the invention is used in the hydraulic sector, wherein the proposed solution for the arrangement of the vent line 6 can principally also be applied to other filter devices such as, for example, fuel or lubricant filters.

In order to prevent an undesirable bypass flow via the vent line 6 during the operation of the pressure filter device 1, a throttle 19 can be provided in the region of the vent line 6 and in particular outside of the filter housing pot 3, which throttle at least limits the undesirable bypass flow. Of course, such a throttle 19 can also be formed by the flexible hose element of the vent line 6 in the section 9, which is advantageous, for example, in an embodiment as shown in FIG. 2.

In general, with the pressure filter device 1 and in particular with the inventive arrangement or mounting of the vent line 6, a significantly simplified maintenance of the pressure filter device 1, in particular when replacing the filter element 5, can be achieved as well as a reliable filtering effect.

In general—as indicated with the broken line in FIG. 3—the vent line 6 can also be attached (e.g. clipped) on the outer circumference of the filter element 5 or the end disks 11, 14, wherein in this case, the lower end disk 14 has on the outer circumference in the axial direction a pin 16′ which engages in the drain channel 15.

1. A pressure filter device, in particular a hydraulic filter device, comprising:
a filter housing having a filter housing pot and a filter housing cover connected to the filter housing pot in a pressure-tight manner,
at least one filter element arranged in the filter housing,
a vent line secured on the filter housing pot and connecting a crude-side gas collection region located directly beneath the filter housing cover to a tank.

2. A pressure filter device, comprising:
a filter housing having a filter housing pot and a filter housing cover connected to the filter housing pot in a pressure-tight manner,
at least one filter element arranged in the filter housing,
a vent line fixed to the filter element and being fed through an upper end disk of the filter element, the event line connecting, via a pure side of the filter element, a crude-side gas collection region located directly beneath the filter housing cover to a tank.

3. The pressure filter device according to claim 1,
wherein the vent line, at least in the gas collection region, is configured as a flexible hose element capable of adapting to an inner contour of the filter housing cover.

4. The pressure filter device according to claim 1,
wherein the vent line, at least in the gas collection region, is configured as a rigid pipe element capable of adapting to an inner contour of the filter housing cover.

5. The pressure filter device according to claim 4,
wherein the pipe element has an articulated joint in a region of a transition between the filter housing cover and the filter housing pot.

6. The pressure filter device according to claim 1,
wherein the vent line penetrates the filter housing pot.

7. The pressure filter device according to claim 1,
further comprising a throttle arranged outside of the filter housing pot.

8. The pressure filter device according to claim 1,
wherein the filter element includes on a lower end disk thereof. a hollow pin configured to engage a drain channel, and further wherein
the vent line is connected via the hollow pin in a communicating manner to the drain channel.

9. The pressure filter device according to claim 8,
further comprising a plurality of protruding nozzles arranged on an upper end disk of the filter element configured to connect to the vent line.

10. The pressure filter device according to claim 2, wherein the vent line, at least in the gas collection region, is configured as a flexible hose element capable of adapting to an inner contour of the filter housing cover.

11. The pressure filter device according to claim 2, wherein the vent line, at least in the gas collection region, is configured as a rigid pipe element capable of adapting to an inner contour of the filter housing cover.

12. The pressure filter device according to claim 11, wherein the pipe element has an articulated joint in a region of a transition between the filter housing cover and the filter housing pot.

13. The pressure filter device according to claim 2, wherein the vent line penetrates the filter housing pot.

14. The pressure filter device according to claim 2, further comprising a throttle arranged outside of the filter housing pot.

15. The pressure filter device according to claim 2, wherein the filter element includes, on a lower end disk thereof, a hollow pin configured to engage a drain channel, and further wherein the vent line is connected via the hollow pin in a communicating manner to the drain channel.

16. The pressure filter device according to claim 15, further comprising a plurality of protruding nozzles arranged on the upper end disk of the filter element configured to connect to the vent line.

17. The pressure filter device according to claim 3, wherein the vent line, at least in the gas collection region, is configured as a rigid pipe element capable of adapting to an inner contour of the filter housing cover.

18. The pressure filter device according to claim 3, wherein the vent line penetrates the filter housing pot.

19. The pressure filter device according to claim 3, further comprising a throttle arranged outside of the filter housing pot.

20. The pressure filter device according to claim 3, wherein the filter element includes, on a lower end disk thereof, a hollow pin configured to engage a drain channel opposite the pure side, and further wherein the vent line is connected via the hollow pin in a communicating manner to the drain channel.
